(19) United States
(12) Patent Application Publication
(10) Pub. No.: US 2017/0155320 A1
(43) Pub. Date: Jun. 1, 2017

(54) VOLTAGE REGULATOR

(71) Applicant: Samsung Electro-Mechanics Co., Ltd., Suwon-si (KR)

(72) Inventor: Soo Woong LEE, Suwon-si (KR)

(73) Assignee: Samsung Electro-Mechanics Co., Ltd., Suwon-si (KR)

(21) Appl. No.: 15/231,936

(22) Filed: Aug. 9, 2016

(30) Foreign Application Priority Data
Nov. 30, 2015 (KR) 10-2015-0169351

(51) Int. Cl. H02M 3/158

(52) U.S. Cl. CPC H02M 3/158

(57) ABSTRACT

A voltage regulator includes: a regulator core configured to provide a first gate signal; a buffer circuit unit configured to buffer the first gate signal to provide a second gate signal; a first switch connected between the buffer circuit unit and a common node; a second switch connected between the regulator core and the common node; and an output transferring device configured to provide a regulated voltage regulated from an operating voltage depending on at least one of the first gate signal and the second gate signal through the common node, wherein the first switch is configured to be maintained in a turned-on state in a first operation mode by a first control signal, the second switch is configured to be maintained in a turned-on state in a second operation mode by a second control signal, and the second operation mode is different than the first operation mode.

### CROSS-REFERENCE TO RELATED APPLICATIONS

This application claims the benefit under 35 U.S.C. 119(a) of Korean Patent Application No. 10-2015-0169351, filed on Nov. 30, 2015 in the Korean Intellectual Property Office, the entire disclosure of which is incorporated herein by reference for all purposes.

### BACKGROUND

1. Field

The following description relates to a voltage regulator apparatus that is capable of being used in an electronic apparatus requiring low power and reduced current consumption.

2. Description of Related Art

Generally, voltage regulators may be used in electronic circuit systems in order to stably control operations of the electronic circuit systems. A low drop output (LDO) type voltage regulator that may down-convert a power supply voltage, be simply designed, and reduce current consumption may be used.

In addition, in order to use the voltage regulator in a small electronic apparatus, it has been required that the voltage regulator be manufactured at a size as small as possible and be operated at low power. A conventional voltage regulator may include a regulator core generating a regulated rated voltage and a buffer assisting in stably operating a circuit in a case in which current loading is present together with the regulated voltage. In this case, the buffer may consume a large amount of current to have a low output impedance in order to efficiently transfer power. Accordingly, the voltage regulator may be unsuitable for use in an application requiring low current consumption.

Therefore, there is a need for a solution to reduce current consumption in a voltage regulator in which a buffer consuming a large amount of current is used in order to stably operate a circuit as described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a voltage regulator includes: a regulator core configured to provide a first gate signal; a buffer circuit unit configured to buffer the first gate signal to provide a second gate signal; a first switch connected between the buffer circuit unit and a common node; a second switch connected between the regulator core and the common node; and an output transferring device configured to provide a regulated voltage regulated from an operating voltage depending on at least one of the first gate signal and the second gate signal through the common node, wherein the first switch is configured to be maintained in a turned-on state in a first operation mode by a first control signal, the second switch is configured to be maintained in a turned-on state in a second operation mode by a second control signal, and the second operation mode is different than the first operation mode.

The second control signal may be a signal inverted from the first control signal, and each of the first and second control signals includes a falling edge delayed by a preset time.

The buffer circuit unit may be configured to be operated in the first operation mode and not operated in the second operation mode by a third control signal phase-locked to the first control signal.

The buffer circuit unit may include: a buffer circuit configured to receive the operating voltage to provide the second gate signal; and a third switch connected between a terminal receiving the operating voltage and the buffer circuit, and configured to be turned on in the first operation mode by a third control signal to supply the operating voltage to the buffer circuit.

The third control signal may be a signal phase-locked to the first control signal. The second control signal may be a signal inverted from the first control signal. Falling edges of the first, second and third control signals are delayed by a preset time.

The voltage regulator of claim 1, wherein the buffer circuit unit is configured to be enabled in the first operation mode and disabled in the second operation mode, and to provide the second gate signal in the first operation mode by using a third control signal.

The voltage regulator may further include a feedback circuit unit configured to detect a feedback voltage at a feedback node between the output transferring device and a ground.

The regulator core may be configured to provide the first gate signal depending on a difference between a reference voltage and the feedback voltage.

According to another general aspect, a voltage regulator includes: a regulator core configured to provide a first gate signal; a buffer circuit unit configured to buffer the first gate signal to provide a second gate signal; a first switch connected between the buffer circuit unit and a common node; a second switch connected between the regulator core and the common node; an output transferring device configured to provide a regulated voltage regulated from an operating voltage depending on at least one of the first gate signal and the second gate signal through the common node; and a switching controller configured to control the first switch to be in a turned-on state using a first control signal in a first operation mode, and to control the second switch to be in a turned-on state using a second control signal in a second operation mode that is different from the first operation mode.

The switching controller may be configured to: invert the first control signal to generate the second control signal; and delay falling edges of the first control signal and the second control signal by a preset time.

The buffer circuit unit may be configured to be operated in the first operation mode and not operated in the second operation mode by a third control signal that is phase-locked to the first control signal.

The buffer circuit unit may include: a buffer circuit configured to receive the operating voltage to provide the second gate signal; and a third switch connected between a terminal receiving the operating voltage and the buffer circuit, and configured to be turned on in the first operation mode by a third control signal to supply the operating voltage to the buffer circuit.

The buffer circuit unit may be configured to be enabled in the first operation mode and disabled in the second operation mode, and to provide the second gate signal in the first operation mode by using a third control signal.

The switching controller may include: a control signal generator configured to generate the first control signal; an inverter configured to invert a phase of the first control signal to provide the second control signal; a first falling edge delay configured to delay the first control signal by a first preset time and output the first control signal; a second falling edge delay configured to delay the second control signal output from the inverter by a second preset time and output the second control signal; and a third falling edge delay configured to delay a third control signal branched from the first control signal by a third preset time and output the third control signal.

The voltage regulator may further include a feedback circuit unit configured to detect a feedback voltage at a feedback node between the output transferring device and a ground.

The regulator core may be configured to provide the first gate signal depending on a difference between a reference voltage and the feedback voltage.

The switching controller may be further configured to: maintain the first control signal and a third control signal branched from the first control signal at a high level in the first operation mode; and change the first and third control signals to a low level at a first point in time corresponding to a change from the first operation mode to the second operation mode.

The switching controller may be further configured to change the second control signal to a high level at a second point in time corresponding to a point in time after a preset period from the first point in time, the second control signal being generated by inverting the first control signal.

Other features and aspects will be apparent from the following detailed description, the drawings, and the claims.

### BRIEF DESCRIPTION OF DRAWINGS

FIG. 1 is a first block circuit diagram illustrating a voltage regulator, according to an embodiment.

FIG. 2 is a block circuit diagram illustrating a voltage regulator, according to another embodiment.

FIG. 3 is a view illustrating a buffer circuit, according to an embodiment.

FIG. 4 is a view illustrating a buffer circuit, according to another embodiment.

FIG. 5 is a detailed circuit diagram illustrating a voltage regulator, according to an embodiment.

FIG. 6 is a view illustrating an implementation of a switching controller, according to an embodiment.

FIGS. 7A and 7B are views illustrating dead zones by first and second control signals, according to an embodiment.

FIG. 8 includes timing diagrams of first to third control signals at a time of changing an operation mode from a first operation mode to a second operation mode, according to an embodiment.

FIG. 9 includes timing diagrams of first to third control signals at a time of changing an operation mode from a second operation mode to a first operation mode, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

The terminology used herein describes particular embodiments only, and the present disclosure is not limited thereby. As used herein, the singular forms “a,” “an,” and “the” are intended to include the plural forms as well, unless the context clearly indicates otherwise.

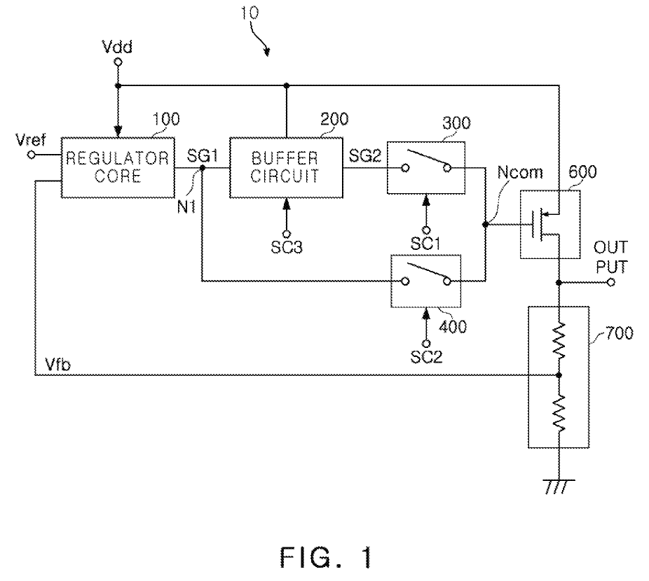

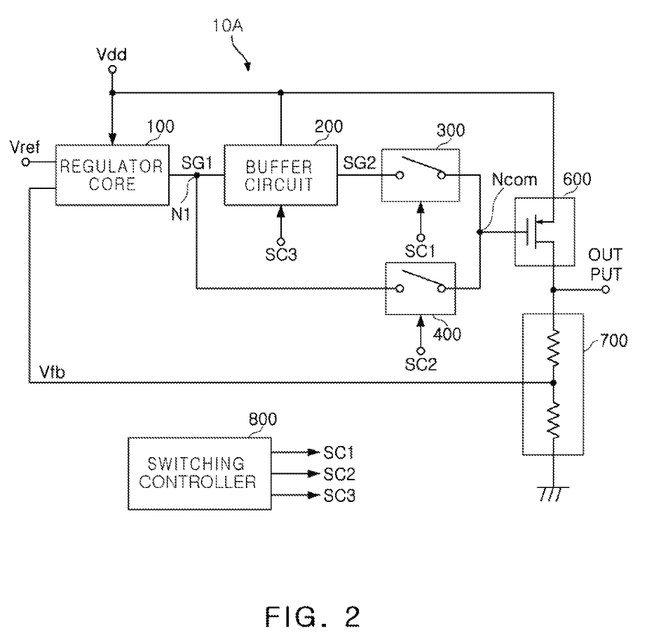

FIG. 1 is a block circuit diagram illustrating a voltage regulator 10, according to an embodiment, and FIG. 2 is a block circuit diagram illustrating a voltage regulator 10A, according to another embodiment. Referring to FIG. 1, the voltage regulator 10 includes a regulator core 100, a buffer circuit unit 200, a first switch 300, a second switch 400, an output transferring device 600, and a feedback circuit unit 700. Referring to FIG. 2, the voltage regulator 10A includes the regulator core 100, the buffer circuit unit 200, the first switch 300, the second switch 400, the output transferring device 600, the feedback circuit unit 700, and a switching controller 800.

Referring to FIGS. 1 and 2, the regulator core 100 provides a first gate signal SG1 depending on a difference between a reference voltage Vref and a feedback voltage Vfb. As an example, the reference voltage Vref is provided from a reference voltage generator, and the feedback voltage Vfb is provided from the feedback circuit unit 700.

The buffer circuit unit 200 buffers the first gate signal SG1 to provide a second gate signal SG2. As an example, the buffer circuit unit 200 provides the second gate signal SG2 having a preset rated current using the first gate signal SG1.

The first switch 300 is connected between the buffer circuit unit 200 and a common node Ncom, and includes at least one switch element. The first switch 300 may be maintained in a turned-on state in a first operation mode by a first control signal SC1 to provide the second gate signal SG2 from the buffer circuit unit 200 to the output transferring device 600 connected to the common node Ncom. The first switch 300 may be turned off in a second operation mode by the first control signal SC1. In this case, an output signal of the buffer circuit unit 200 may be blocked by the first switch 300.

The first operation mode may be an operation mode in which an operation of the buffer circuit unit 200 is required. As an example, the first operation mode may be a normal operation mode or a normal operation mode and a standby mode. In addition, the second operation mode may be an operation mode in which the operation of the buffer circuit unit 200 is not required. As an example, the second operation mode may be a low power standby mode.

Since a power requirement related to the operation mode may be changed depending on a voltage condition and a situation of an application system, the examples of the operation modes as described above are only examples, and the operation modes are not limited to these examples.

The second switch 400 may be connected between an output node N1 of the regulator core unit 100 and the common node Ncom, and may include at least one switch element. As an example, the second switch 400 is maintained in a turned-on state in the second operation mode different from the first operation mode by a second control signal SC2 to provide the first gate signal SG1 from the regulator core unit 100 to the output transferring device 600 connected to the common node Ncom. In contrast, the second switch 400 may be turned off in the first operation mode by the second control signal SC2. In this case, a bypass path providing an output signal of the regulator core 100 to an output terminal OUTPUT without passing through the buffer circuit unit 200 may be blocked by the second switch 400.

The output transferring device 600 provides a regulated voltage Vreg, which is regulated from an operating voltage Vdd, to the output terminal OUTPUT, depending on at least one of the first gate signal SG1 or the second gate signal SG2 through the common node Ncom. In addition, referring to FIGS. 1 and 2, the feedback circuit unit 700 detects the feedback voltage Vfb at a feedback node between the output transferring device 600 and a ground, and provides the feedback voltage Vfb to the regulator core 100.

In the embodiment of FIG. 2, the switching controller 800 may control the first switch 300 to be in a turned-on state using the first control signal SC1 in the first operation mode, and may control the second switch 300 to be in a turned-on state using the second control signal SC2 in the second operation mode. As an example, the switching controller 800 inverts the first control signal SC1 and delays the inverted first control signal SC1 by a preset time to generate the second control signal SC2.

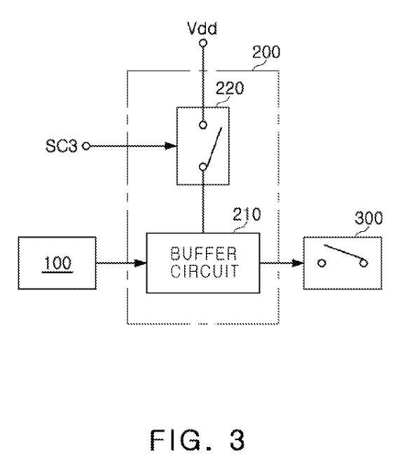

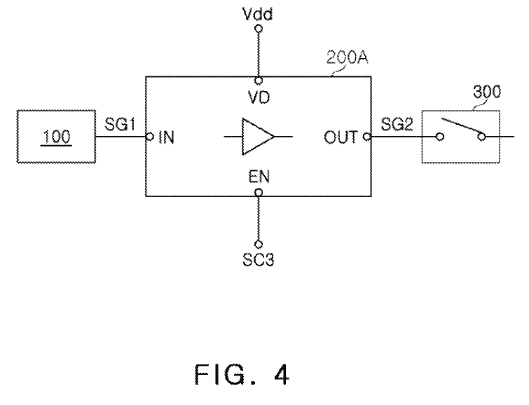

The buffer circuit unit 200 is operated in the first operation mode and is not operated in the second operation mode by a third control signal SC3 phase-locked to the first control signal SC1. The buffer circuit unit 200 and a buffer circuit unit 200A according to another embodiment will be described with reference to FIGS. 3 and 4.

FIG. 3 is a view illustrating the buffer circuit unit 200, according to an embodiment. Referring to FIG. 3, the buffer circuit unit 200 includes a buffer circuit 210 and a third switch 220. The third switch 220 is connected between a terminal receiving the operating voltage Vdd and the buffer circuit 210, and may be turned on in the first operation mode by the third control signal SC3 to supply the operating voltage Vdd to the buffer circuit 210. In contrast, the third switch 220 may be turned off by the third control signal SC3 in the second operation mode.

In the first operation mode, the buffer circuit 210 may receive the operating voltage Vdd through the third switch 220 to provide the second gate signal SG2. Therefore, the output transferring unit 600 may provide a current required at the output terminal OUTPUT on the basis of the signal from the buffer circuit 210. Therefore, the buffer circuit 210 may consume a current in order to assist the output transferring device 600 in providing the current required at the output terminal OUTPUT.

FIG. 4 is a view illustrating a buffer circuit unit 200A, according to another embodiment. The buffer circuit unit 200A may be used in place of the buffer circuit unit 200 shown and described herein with respect to the embodiments of FIGS. 1, 2 and 5.

Referring to FIG. 4, the buffer circuit unit 200A may be implemented by an integrated circuit having an input terminal IN configured to receive the first gate signal SG1 input from the regulator core 100, an output terminal OUT configured to output the second gate signal SG2, a power supply terminal VD configured to receive the operating voltage Vdd, and an enable terminal EN configured to receive the third control signal SC3. The buffer circuit unit 200A may be enabled (e.g., made operable) in the first operation mode or may be disabled (e.g., made inoperable) in the second operation mode by the third control signal SC3 input through the enable terminal EN.

As an example, in response to a voltage level of the third control signal SC3 being a high level, the buffer circuit unit 200A is enabled, and in response to a voltage level of the third control signal SC3 being a low level, the buffer circuit unit 200A is disabled.

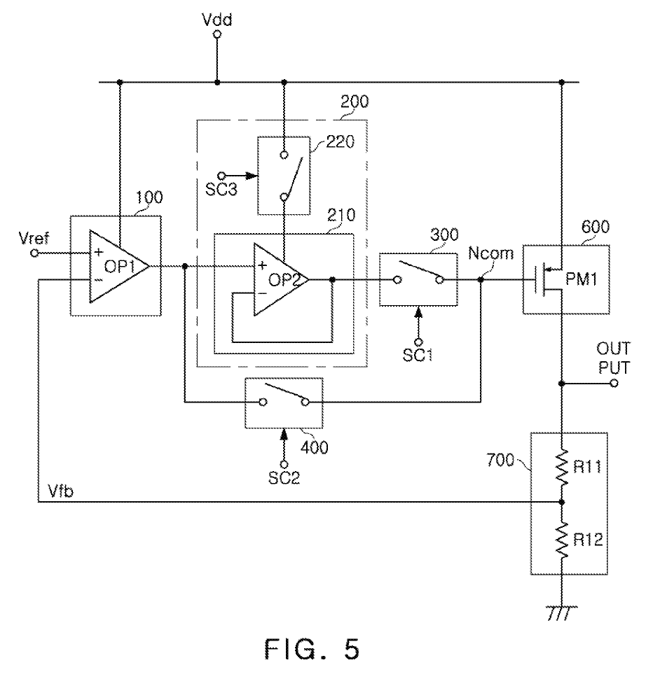

FIG. 5 is a detailed circuit diagram illustrating the voltage regulator 10 in greater detail, according to an embodiment.

Referring to FIG. 5, the regulator core 100 includes a first operational amplifier OP1 that has an inverting input terminal configured to receive the reference voltage Vref, a non-inverting input terminal configured to receive the feedback voltage Vfb, and an output terminal configured to provide the first gate signal SG1 and operated by receiving the operating voltage Vdd.

The buffer circuit unit 200 includes the third switch 220 and the buffer circuit 210, as illustrated in FIG. 3. The buffer circuit 210 includes a second operational amplifier OP2 that has a non-inverting input terminal configured to receive the first gate signal SG1 from the regulator core 100, an inverting input terminal connected to an output terminal of the buffer circuit unit 200, and an output terminal configured to provide the second gate signal SG2 and operated by receiving the operating voltage Vdd through the third switch 220.

The output transferring device 600 includes a P-channel metal oxide semiconductor (PMOS) transistor PM1 that has a source connected to a terminal receiving the operating voltage Vdd, a gate connected to the common node Ncom to receive at least one of the first gate signal SG1 and the second gate signal SG2, and a drain connected to the feedback circuit unit 700 and the output terminal OUTPUT and configured to provide the regulated voltage Vreg through the output terminal OUTPUT depending on the signal supplied to the gate. In addition, the feedback circuit unit 700 includes at least two resistors R11 and R12 connected to each other in series between the output terminal OUTPUT and the ground. In this case, the feedback voltage Vfb is provided from the feedback node, which is a connection node between the two resistors R11 and R12.

The first switch 300, the second switch 400, and the third switch 220 according to the embodiments disclosed herein each may at least one switch element. In this case, the switch element may be an element that performs a switching operation by a control signal. As an example, at least one of three-terminal semiconductor elements such as various transistors, for example, an MOS transistor, a silicon controlled rectifier (SCR) element, a transfer gate, and the like, may be used as the switch element.

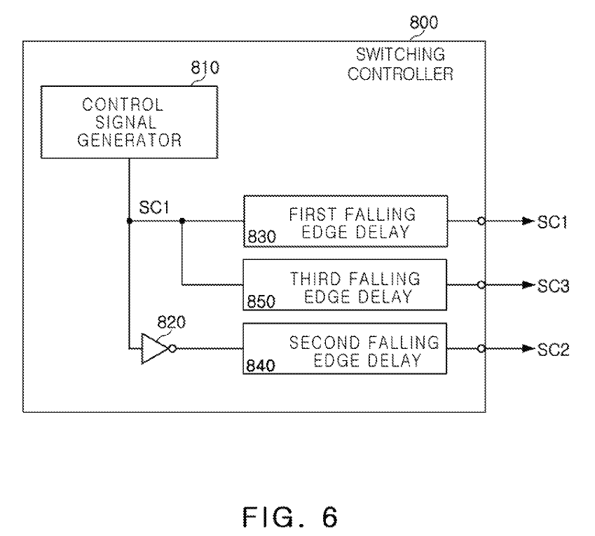

The second control signal SC2 may be a signal inverted from the first control signal SC1, and vice versa, and each of the first and second control signals SC1 and SC2 may be a signal of which a falling edge is delayed by a preset time. An example of the generation of the first and second control signals SC1 and SC2 will be described with reference to FIG. 6.

FIG. 6 is a view illustrating a first implementation of a switching controller 800, according to an embodiment. Referring to FIG. 6, the switching controller 800 includes a control signal generator 810, an inverter 820, a first falling edge delay 830, a second falling edge delay 840, and a third falling edge delay 850.

The control signal generator 810 generates the first control signal SC1. The inverter 820 inverts a phase of the first control signal SC1 to provide the second control signal SC2. The first falling edge delay 830 delays the first control signal by a preset time and then outputs the first control signal SC1, and the second falling edge delay 840 delays the second control signal output by the inverter 820 by a preset time and then outputs the second control signal SC2. In addition, the third falling edge delay 850 delays the third control signal SC3 branched from the first control signal SC1 by a preset time and then outputs the third control signal SC3.

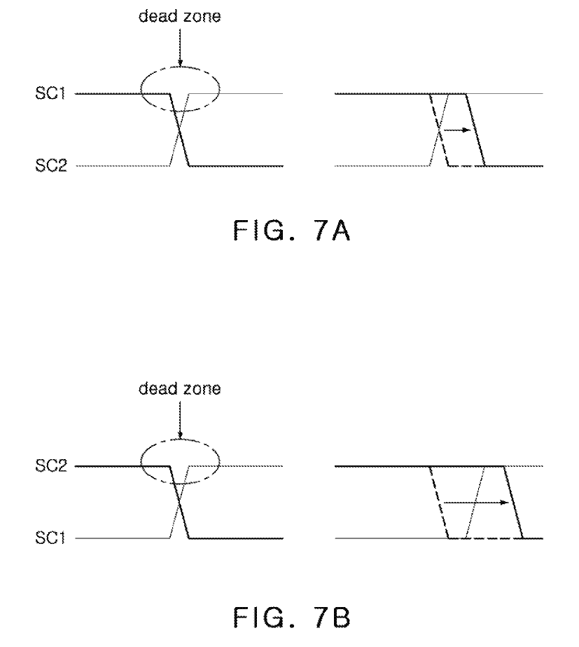

FIGS. 7A and 7B are views illustrating dead zones produced by the first and second control signals SC1 and SC2, according to an embodiment. Referring to FIGS. 7A and 7B, in a case in which the first switch 300 and the second switch 400 simultaneously perform turn-on and turn-off operations by the first and second control signals SC1 and SC2, a dead zone in which intermediate levels between high levels and low levels of the first and second control signals SC1 and SC2 coexist is present.

In a case in which the dead zone as described above is present, there is the possibility that a malfunction will occur in the first switch 300 and the second switch 400. In order to remove the dead zone as described above, the switching controller 800 may invert the first control signal SC1 and then provides the second control signal SC2 of which a falling edge is delayed by a preset time, and vice versa.

As an example, the first control signal SC1 may be a signal delayed by a preset time after the second control signal SC2 is inverted, as illustrated in FIG. 7A, and the second control signal SC2 may be a signal delayed by a preset time after the first control signal SC1 is inverted, as illustrated in FIG. 7B.

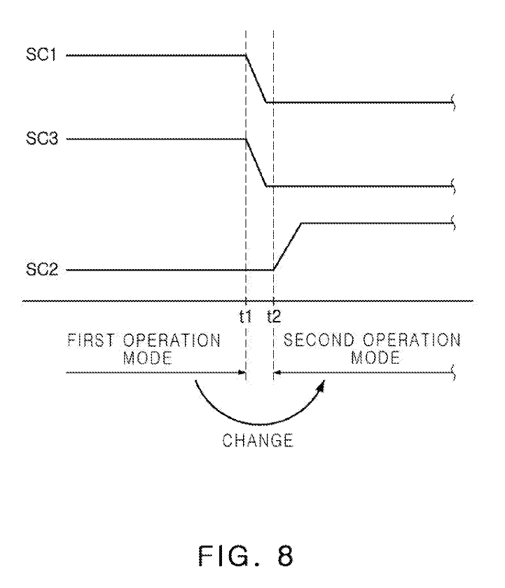

FIG. 8 includes timing diagrams of the first to third control signals SC1-SC3 at the time of changing an operation mode (e.g., from a first operation mode to a second operation mode), according to an embodiment. Referring to FIG. 8, the first and third control signals SC1 and SC3 may be maintained at a high level in the first operation mode and may be changed to a low level at a first point in time t1, which is an operation mode changing point in time, by the switching controller 800. The second control signal SC2 may be changed to a high level at a second point in time t2 corresponding to a point in time after a preset period from the first point in time t1, by the switching controller 800. Therefore, a dead zone between the first and second control signals SC1 and SC2 may not be present.

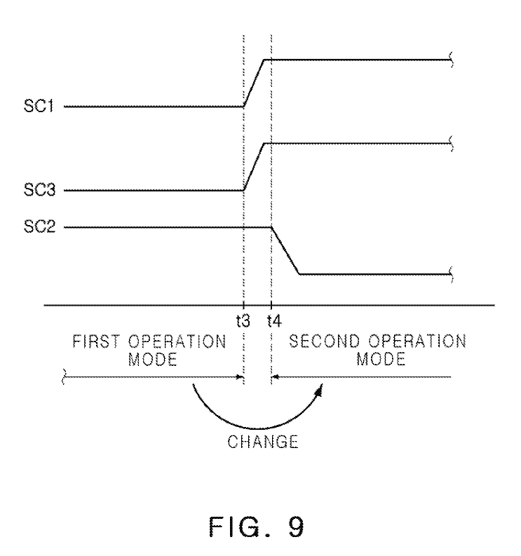

FIG. 9 includes timing diagrams of the first to third control signals SC1-SC3 at the time of changing an operation mode (from a second operation mode to a first operation mode), according to an embodiment. Referring to FIG. 9, the first and third control signals SC1 and SC3 may be maintained at a low level in the second operation mode and may be changed into a high level at a third point in time t3, which is an operation mode changing point in time, by the switching controller 800. The second control signal SC2 may be changed into a low level at a fourth point in time t4 corresponding to a point in time after a preset period from the third point in time t3, by the switching controller 800. Therefore, a dead zone between the first and second control signals SC1 and SC2 may not be present.

As set forth above, according to embodiments disclosed herein, a circuit required for current loading is turned off in a low power operation mode in which the current loading is not required among operation modes, whereby current consumption may be reduced.

The apparatuses, units, modules, devices, and other components (e.g., the regulator core 100, the buffer circuit unit 200, the buffer circuit 210, the switching controller 800, the control signal generator 810 and the falling edge delays 830, 840 and 850) illustrated in FIGS. 1-6 that perform the operations described herein with respect to FIGS. 3-9 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 3-9. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

A user interface may provide the capability of inputting and outputting information regarding a user and an image. The user interface may include a network module for connecting to a network and a universal serial bus (USB) host module for forming a data transfer channel with a mobile storage medium. In addition, the user interface may include one or more input/output devices, such as a mouse, a keyboard, a touch screen, a monitor, a speaker, a screen, or a software module for controlling the input/output device.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A voltage regulator, comprising:
a regulator core configured to provide a first gate signal; a buffer circuit unit configured to buffer the first gate signal to provide a second gate signal;
a first switch connected between the buffer circuit unit and a common node;
a second switch connected between the regulator core and the common node; and
an output transferring device configured to provide a regulated voltage regulated from an operating voltage depending on at least one of the first gate signal and the second gate signal through the common node,
wherein the first switch is configured to be maintained in a turned-on state in a first operation mode by a first control signal, the second switch is configured to be maintained in a turned-on state in a second operation mode by a second control signal, and the second operation mode is different than the first operation mode.

2. The voltage regulator of claim 1, wherein the second control signal is a signal inverted from the first control signal, and each of the first and second control signals comprises a falling edge delayed by a preset time.

3. The voltage regulator of claim 1, wherein the buffer circuit unit is configured to be operated in the first operation mode and not operated in the second operation mode by a third control signal phase-locked to the first control signal.

4. The voltage regulator of claim 1, wherein the buffer circuit unit comprises:
a buffer circuit configured to receive the operating voltage to provide the second gate signal; and
a third switch connected between a terminal receiving the operating voltage and the buffer circuit, and configured to be turned on in the first operation mode by a third control signal to supply the operating voltage to the buffer circuit.

5. The voltage regulator of claim 4, wherein:
the third control signal is a signal phase-locked to the first control signal;
the second control signal is a signal inverted from the first control signa; and
falling edges of the first, second and third control signals are delayed by a preset time.

6. The voltage regulator of claim 1, wherein the buffer circuit unit is configured to be enabled in the first operation mode and disabled in the second operation mode, and to provide the second gate signal in the first operation mode by using a third control signal.

7. The voltage regulator of claim 1, further comprising a feedback circuit unit configured to detect a feedback voltage at a feedback node between the output transferring device and a ground.

8. The voltage regulator of claim 7, wherein the regulator core is configured to provide the first gate signal depending on a difference between a reference voltage and the feedback voltage.

9. A voltage regulator comprising:
a regulator core configured to provide a first gate signal;
a buffer circuit unit configured to buffer the first gate signal to provide a second gate signal;
a first switch connected between the buffer circuit unit and a common node;
a second switch connected between the regulator core and the common node;
an output transferring device configured to provide a regulated voltage regulated from an operating voltage depending on at least one of the first gate signal and the second gate signal through the common node; and
a switching controller configured to control the first switch to be in a turned-on state using a first control signal in a first operation mode, and to control the second switch to be in a turned-on state using a second control signal in a second operation mode that is different from the first operation mode.

10. The voltage regulator of claim 9, wherein the switching controller is configured to:
invert the first control signal to generate the second control signal; and
delay falling edges of the first control signal and the second control signal by a preset time.

11. The voltage regulator of claim 9, wherein the buffer circuit unit is configured to be operated in the first operation mode and not operated in the second operation mode by a third control signal that is phase-locked to the first control signal.

12. The voltage regulator of claim 9, wherein the buffer circuit unit includes:
a buffer circuit configured to receive the operating voltage to provide the second gate signal; and
a third switch connected between a terminal receiving the operating voltage and the buffer circuit, and configured to be turned on in the first operation mode by a third control signal to supply the operating voltage to the buffer circuit.

13. The voltage regulator of claim 9, wherein the buffer circuit unit is configured to be enabled in the first operation mode and disabled in the second operation mode, and to provide the second gate signal in the first operation mode by using a third control signal.

14. The voltage regulator of claim 9, wherein the switching controller comprises:
a control signal generator configured to generate the first control signal;
an inverter configured to invert a phase of the first control signal to provide the second control signal;
a first falling edge delay configured to delay the first control signal by a first preset time and output the first control signal;
a second falling edge delay configured to delay the second control signal output from the inverter by a second preset time and output the second control signal; and
a third falling edge delay configured to delay a third control signal branched from the first control signal by a third preset time and output the third control signal.

15. The voltage regulator of claim 9, further comprising a feedback circuit unit configured to detect a feedback voltage at a feedback node between the output transferring device and a ground.

16. The voltage regulator of claim 15, wherein the regulator core is configured to provide the first gate signal depending on a difference between a reference voltage and the feedback voltage.

17. The voltage regulator of claim 9, wherein the switching controller is further configured to:
maintain the first control signal and a third control signal branched from the first control signal at a high level in the first operation mode; and
change the first and third control signals to a low level at a first point in time corresponding to a change from the first operation mode to the second operation mode.

18. The voltage regulator of claim 17, wherein the switching controller is further configured to change the second control signal to a high level at a second point in time corresponding to a point in time after a preset period from the first point in time, the second control signal being generated by inverting the first control signal.
